(19) United States
(12) Patent Application Publication
(10) Pub. No.: US 2011/0264760 A1
(43) Pub. Date: Oct. 27, 2011

(54) METHOD AND APPARATUS PROVIDING FOR OUTPUT OF A CONTENT PACKAGE BY AN APPLICATION BASED AT LEAST IN PART ON A CONTENT TYPE SELECTION AND ONE OR MORE CONTEXTUAL CHARACTERISTICS

(75) Inventors: Sailesh Kumar Sathish, Tampere (FI); Sami Pekka Henrik Vaskuu, Tampere (FI)

(73) Assignee: Nokia Corporation

(21) Appl. No.: 12/764,542

(22) Filed: Apr. 21, 2010

(51) Int. Cl. G06F 15/16

(52) U.S. Cl. 709/217

(57) ABSTRACT

An apparatus providing for output of a content package by an application may include a content type selector for receiving a content type selection from the application. A channel selector may be configured to receive a channel selection. The apparatus may further comprise a contextual characteristic determiner for determining one or more contextual characteristics. The apparatus may thereby provide for selection of a content package based at least in part on the content category selection and the one or more contextual characteristics. The actual selection of the content package may occur in an external device, such as a content package selector. Accordingly, a content requestor may act as an interface between the content package selector and the applications running on the apparatus. Once the content package is selected, the apparatus may provide for output of the content package such as by the application displaying the content package on a display.

### TECHNOLOGICAL FIELD

Embodiments of the present invention relate generally to outputting content, such as by displaying the content and, more particularly, relate to an apparatus, method and a computer program product providing for output of a content package by an application based at least in part on a content type selection from the application and one or more contextual characteristics.

### BACKGROUND

In order to provide easier or faster information transfer and convenience, telecommunication industry service providers are continually developing improvements to existing communication networks. As a result, wireless communication has become increasingly more reliable in recent years. Along with the expansion and improvement of wireless communication networks, mobile terminals used for wireless communication have also been continually improving. In this regard, due at least in part to reductions in size and cost, along with improvements in battery life and computing capacity, mobile terminals have become more capable, easier to use, and cheaper to obtain. Due to the now ubiquitous nature of mobile terminals, people of all ages and education levels are utilizing mobile terminals to communicate with other individuals or contacts, receive services and/or share information, media and other content.

Some of the technologies which are becoming more popular are that of location based services and other personalized services. In this regard, some technologies may provide users of properly equipped mobile terminals with content which is specific to the present location of the user, or other contextual information. Thus, for example, the user may be provided with weather information relating to the user's present location. In other instances the user may be provided with information such as Uniform Resource Locators (URLs) which relate to one or both of the user's interests and the user's present location. Thereby, content may be provided to the user automatically. This content may in some cases be displayed on the home screen of the mobile terminal.

### BRIEF SUMMARY

A method, apparatus and computer program product are therefore provided that may provide for output of a content package by an application. The content package, which may, for example, comprise URL links or other content segments such as pictures, data, audio, or video, may be chosen based at least in part on a content type selection from the application and on one or more relevant contextual characteristics.

In an example embodiment, an improved apparatus comprises at least one processor and at least one memory including computer program code, the at least one memory and the computer program code configured to, with the processor, cause the apparatus to receive a content type selection from an application, determine one or more contextual characteristics via a processor, provide the content type selection and the one or more contextual characteristics to permit selection of a content package, and provide for output of the content package by the application.

The apparatus may also be configured to use the application to determine the one or more contextual characteristics and determine one or more application contextual characteristics. Further, the apparatus may be configured to receive a channel selection from the application and subscribe to the channel selection. Additionally, the apparatus may be further configured to direct a content request through a content requestor and receive the content package through the content requestor. Also, the apparatus may be configured to manage a user profile with the content requestor.

In an additional example embodiment a method comprises receiving a content type selection from an application, determining one or more contextual characteristics, providing the content type selection and the one or more contextual characteristics to permit selection of a content package, and providing for output of the content package by the application.

In some embodiments the method may also comprise using the application to determine the one or more contextual characteristics. Further, the method may comprise determining one or more application contextual characteristics. Additionally, the method may include receiving a channel selection from the application. The method may also comprise subscribing to the channel selection. Further, in some embodiments providing the content type selection and the one or more contextual characteristics comprises directing a content request through a content requestor and receiving the content package through the content requestor. Additionally, the method may include managing a user profile with the content requestor.

In a further example embodiment a computer program product comprises at least one computer-readable storage medium having computer-executable program code portions stored therein, the computer-executable program code portions comprising program code instructions for receiving a content type selection from an application, program code instructions for determining one or more contextual characteristics, program code instructions providing the content type selection and the one or more contextual characteristics to permit selection of a content package, and program code instructions providing for output of the content package by the application.

In some embodiments the computer program product may further comprise program code instructions for using the application to determine the one or more contextual characteristics. Additionally, the computer program product may comprise program code instructions for determining one or more application contextual characteristics. The computer program product may further include program code instructions for receiving a channel selection from the application. The computer program product may also comprise program code instructions for subscribing to the channel selection. Additionally, program code instructions providing the content type selection and the one or more contextual characteristics may comprise program code instructions for directing a content request through a content requestor and program code instructions for receiving the content package through the content requestor.

Accordingly, embodiments of the present invention may provide for improved outputting of a content package by an application based at least in part on a content type selection and one or more contextual characteristics.

### BRIEF DESCRIPTION OF THE SEVERAL VIEWS OF THE DRAWING(S)

Having thus described embodiments of the present disclosure in general terms, reference will now be made to the accompanying drawings, which are not necessarily drawn to scale, and wherein:

FIG. 1 illustrates a schematic block diagram of a system according to an example embodiment of the present invention;

FIG. 2 illustrates a schematic block diagram of an apparatus providing for output of a content package by an application according to an example embodiment of the present invention; and

FIG. 3 illustrates a flowchart according to an example method providing for output of a content package by an application in accordance with an example embodiment of the present invention.

### DETAILED DESCRIPTION

Some embodiments of the present invention will now be described more fully hereinafter with reference to the accompanying drawings, in which some, but not all embodiments of the invention are shown. Indeed, various embodiments of the invention may be embodied in many different forms and should not be construed as limited to the embodiments set forth herein. Like reference numerals refer to like elements throughout. As used herein, the terms “data,” “content,” “information” and similar terms may be used interchangeably to refer to data capable of being transmitted, received and/or stored in accordance with embodiments of the present invention. Moreover, the term “exemplary”, as used herein, is not provided to convey any qualitative assessment, but instead merely to convey an illustration of an example. Thus, use of any such terms should not be taken to limit the spirit and scope of embodiments of the present invention.

As used herein, the term ‘circuitry’ refers to (a) hardware-only circuit implementations (for example, implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device, and/or other computing device.

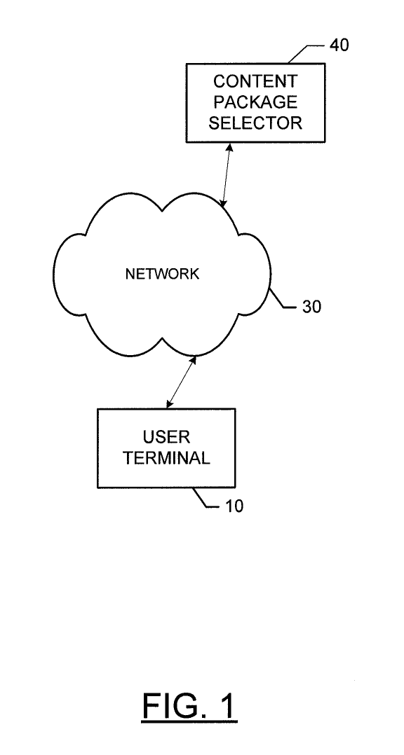

As indicated above, embodiments of the present invention may be employed in methods, apparatuses and computer program products providing for output of a content package by an application. An applications, as used herein, refers to software, programs, and other stored instructions which are configured to perform one or more tasks. In this regard, for example, FIG. 1 illustrates a block diagram of a system that may benefit from embodiments of the present invention. It should be understood, however, that the system as illustrated and hereinafter described is merely illustrative of one system that may benefit from embodiments of the present invention and, therefore, should not be taken to limit the scope of embodiments of the present invention.

As shown in FIG. 1, an embodiment of a system in accordance with an example embodiment of the present invention may include a user terminal 10. The user terminal 10 may be any of multiple types of fixed or mobile communication and/or computing devices such as, for example, portable digital assistants (PDAs), pagers, mobile televisions, mobile telephones, gaming devices, laptop computers, personal computers (PCs), cameras, camera phones, video recorders, audio/video players, radios, global positioning system (GPS) devices, or any combination of the aforementioned, and other types of voice and text communications systems, which employ embodiments of the present invention.

The user terminal 10 may be configured for an application to output a content package, which may comprise individual content segments such as URL links. However, the content package may include other content types such as pictures, data, audio, or video. In some embodiments the user terminal 10 may be capable of communicating with other devices, either directly, or via a network 30. The network 30 may include a collection of various different nodes, devices or functions that may be in communication with each other via corresponding wired and/or wireless interfaces. As such, the illustration of FIG. 1 should be understood to be an example of a broad view of certain elements of the system and not an all inclusive or detailed view of the system or the network 30. Although not necessary, in some embodiments, the network 30 may be capable of supporting communication in accordance with any one or more of a number of first-generation (1G), second-generation (2G), 2.5G, third-generation (3G), 3.5G, 3.9G, fourth-generation (4G) mobile communication protocols, Long Term Evolution (LTE), and/or the like. Thus, the network 30 may be a cellular network, a mobile network and/or a data network, such as a local area network (LAN), a metropolitan area network (MAN), and/or a wide area network (WAN), for example, the Internet. In turn, other devices such as processing elements (for example, personal computers, server computers or the like) may be included in or coupled to the network 30. By directly or indirectly connecting the user terminal 10 and the other devices to the network 30, the user terminal 10 and/or the other devices may be enabled to communicate with each other, for example, according to numerous communication protocols including Hypertext Transfer Protocol (HTTP) and/or the like, to thereby carry out various communication or other functions of the mobile terminal 10 and the other devices, respectively. As such, the user terminal 10 and the other devices may be enabled to communicate with the network 30 and/or each other by any of numerous different access mechanisms. For example, mobile access mechanisms such as wideband code division multiple access (W-CDMA), CDMA2000, global system for mobile communications (GSM), general packet radio service (GPRS) and/or the like may be supported as well as wireless access mechanisms such as wireless LAN (WLAN), Worldwide Interoperability for Microwave Access (WiMAX), WiFi, ultra-wide band (UWB), Wibree techniques and/or the like and fixed access mechanisms such as digital subscriber line (DSL), cable modems, Ethernet and/or the like. Thus, for example, the network 30 may be a home network or other network providing local connectivity.

The system may further comprise a content package selector 40 which may be in communication with the user terminal 10 either directly, or through the network 30. As will be described in detail below, the content package selector 40 may be configured to select a content package and transmit it to the user terminal 10. Specifically, the content package selector 40 may be configured to receive a content type selection and one or more contextual characteristics from the user terminal 10, and select a content package for the user terminal based at least in part on the content type selection and the one or more contextual characteristics. In some embodiments the content package selector 40 may be a generic content package selector which is configured to recognize content types through use of plug-ins. Communication between the user terminal 10 and the content package selector 40 may occur, by way of example, via direct Application Programming Interface (API) call, Desktop Bus (D-BUS) communication, or Transmission Control Protocol (TCP) communication or other methods. By way of further example, the content requests may be in the form of HTTP data, and signaling may be Extensible Messaging and Presence Protocol (XMPP) based.

The content package selector 40 may for example be a server, server bank or other computer or other computing device or node configured to select a content package. The content package selector 40 may have any number of functions or associations with various services. As such, for example, the content package selector 40 may be a platform such as a dedicated server (or server bank), or the content package selector may be a backend server associated with one or more other functions or services. Thus, the content package selector 40 may potentially select a variety of different content packages. In some embodiments the content package selector 40 may select and distribute commercial and/or non-commercial content. Accordingly, the operations performed by the content package selector 40 may or may not comprise processing payment in exchange for distributing the content. In some embodiments payment may be processed by a separate device. Further, although the content package selector 40 is herein generally described as a server, in some embodiments the content package selector may be embodied as a portion of the user terminal 10, such as an internal module therein.

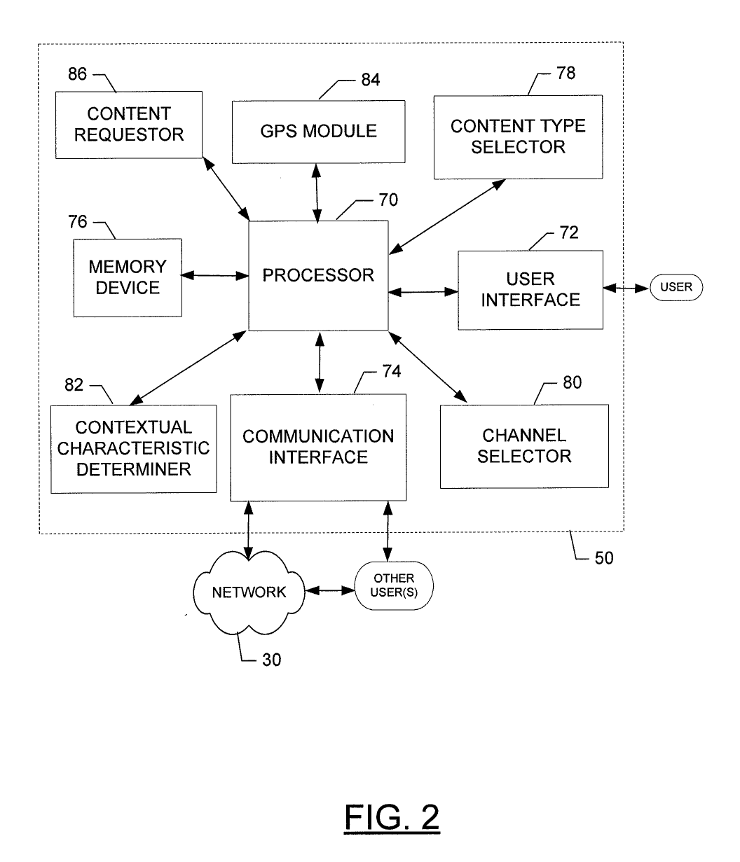

In an example embodiment, an apparatus 50 is provided that may be employed by devices performing example embodiments of the present invention. The apparatus 50 may be embodied, for example, as any device hosting, including, controlling or otherwise comprising the user terminal 10. However, embodiments may also be embodied on a plurality of other devices such as for example where instances of the apparatus 50 may be embodied on the network 30 and/or the content package selector 40. As such, the apparatus 50 of FIG. 2 is merely an example and may include more, or in some cases less, than the components shown in FIG. 2.

With further regard to FIG. 2, the apparatus 50 is configured to provide for output of a content package by an application, such as by displaying a content package selected by the content package selector 40 based at least in part on a content type selection and one or more contextual characteristics. The apparatus 50 may include or otherwise be in communication with a processor 70, a user interface 72, a communication interface 74 and a memory device 76. The memory device 76 may include, for example, volatile and/or non-volatile memory. The memory device 76 may be configured to store information, data, files, applications, instructions or the like. For example, the memory device 76 could be configured to buffer input data for processing by the processor 70. Additionally or alternatively, the memory device 76 could be configured to store instructions for execution by the processor 70. As yet another alternative, the memory device 76 may be one of a plurality of databases or storage locations that store information and/or media content.

The processor 70 may be embodied in a number of different ways. For example, the processor 70 may be embodied as one or more of various processing means such as a coprocessor, a microprocessor, a controller, a digital signal processor (DSP), processing circuitry with or without an accompanying DSP, or various other processing devices including integrated circuits such as, for example, an ASIC (application specific integrated circuit), an FPGA (field programmable gate array), a hardware accelerator, a special-purpose computer chip, or the like. In an example embodiment, the processor 70 may be configured to execute instructions stored in the memory device 76 or otherwise accessible to the processor 70. Alternatively or additionally, the processor 70 may be configured to execute hard coded functionality. As such, whether configured by hardware or software methods, or by a combination thereof, the processor 70 may represent an entity (for example, physically embodied in circuitry) capable of performing operations according to embodiments of the present invention while configured accordingly. Thus, for example, when the processor 70 is embodied as an ASIC, FPGA or the like, the processor 70 may be specifically configured hardware for conducting the operations described herein. Alternatively, as another example, when the processor 70 is embodied as an executor of software instructions, the instructions may specifically configure the processor 70 to perform the algorithms and/or operations described herein when the instructions are executed. However, in some cases, the processor 70 may be a processor of a specific device (for example, a mobile terminal or network device such as a server) adapted for employing embodiments of the present invention by further configuration of the processor 70 by instructions for performing the algorithms and/or operations described herein. The processor 70 may include, among other things, a clock, an arithmetic logic unit (ALU) and logic gates configured to support operation of the processor 70. In some embodiments the processor may be configured to execute one or more applications. In some embodiments the processor may run an operating system configured to execute the applications.

Meanwhile, the communication interface 74 may be any means such as a device or circuitry embodied in either hardware, software, or a combination of hardware and software that is configured to receive and/or transmit data from/to a network and/or any other device or module in communication with the apparatus 50. In this regard, the communication interface 74 may include, for example, an antenna (or multiple antennas) and supporting hardware and/or software for enabling communications with a wireless communication network (for example, network 30). In fixed environments, the communication interface 74 may alternatively or also support wired communication. As such, the communication interface 74 may include a communication modem and/or other hardware/software for supporting communication via cable, digital subscriber line (DSL), universal serial bus (USB), Ethernet, High-Definition Multimedia Interface (HDMI) or other mechanisms. Furthermore, the communication interface 74 may include hardware and/or software for supporting communication mechanisms such as BLUETOOTH®, Infrared, UWB, WiFi, and/or the like, which are being increasingly employed in connection with providing home connectivity solutions.

The user interface 72 may be in communication with the processor 70 to receive an indication of a user input at the user interface and/or to provide an audible, visual, mechanical or other output to the user. As such, the user interface 72 may include, for example, a keyboard, a mouse, a joystick, a display, a touch screen, a microphone, a speaker, or other input/output mechanisms.

The apparatus 50 may comprise a content type selector 78, which is configured to receive a content type selection from an application. The processor 70 may be embodied as, include or otherwise control the content type selector 78. In some embodiments the content type selection may occur within the application, and accordingly the content type selector 78 may be embodied within the application. The content type selection may be in some embodiments be made automatically by the application. For example, in some embodiments a generic request for content by the application may be configured to correspond with a predetermined content type. Whereas in some embodiments the user may make the content type selection, for example when the application is configured to output more than one type of content. Thus, in some embodiments the content type selector 78 may be embodied by an interface within the application allowing for selection of a desired content type. Accordingly, the apparatus 50 may receive a content type selection, for example music, videos, URLs, etc. using the content type selector 78. The content type selector 78 may in some embodiments receive a list of available content types from the content package selector 40 which may be updated as required.

The apparatus 50 may in some embodiments additionally comprise a channel selector 80 which is configured to receive a channel selection from an application. A channel herein refers to a subset of a content type. For example, within the content type of music, there may be a wide variety of channels including rock, country, alternative, rap, etcetera, and other channels of greater or less specificity. The processor 70 may be embodied as, include or otherwise control the channel selector 80. In some embodiments the channel selection may occur within the application, and accordingly the channel selector 80 may be embodied within the application. The channel selection may in some embodiments be made automatically by the application, whereas in other embodiments the user may make the channel selection, for example when the application is configured to output more than one channel of content. Thus, in some embodiments the channel selector 80 may be embodied by an interface within the application which allows for selection of one or more desired channels. Accordingly, the apparatus 50 may receive a channel selection using the channel selector 80. Further, in some embodiments the channel selector 80 may allow the user to create, update (when the user has the proper administrative right), and/or subscribe to channels. Subscriptions to channels may thereby cause an application to output the same channel upon each use of the application, unless the subscription is updated to a new channel. Additionally, the channel selector 78 may in some embodiments receive a list of available channels from the content package selector 40 which may be updated as required.

In some embodiments the apparatus 50 may include a contextual characteristic determiner 82, which may determine one or more contextual characteristics. Contextual characteristics may include the present time, location, activity, etc. of the user and/or the apparatus 50. The processor 70 may be embodied as, include or otherwise control the contextual characteristic determiner 82. Thus, for example, the contextual characteristic determiner 82 may determine that the user is presently at home, or outside walking. Information relating to the location of the user may, for example, be provided by a GPS module 84, though location information may additionally or alternatively be provided through other means such as triangulation using cell phone towers in some embodiments. Thus, the apparatus 50 may determine one or more contextual characteristics. In some embodiments the contextual characteristics may comprise application contextual characteristics which relate to the state of the application, such as which functions of the application are currently in use. The application contextual characteristics and other contextual characteristics may in some embodiments be determined by the application itself. Thus, in some embodiments of the invention the application may embody the contextual characteristic determiner 82.

Further, in some embodiments the apparatus 50 may comprise a content requestor 86. The processor 70 may be embodied as, include or otherwise control the content requestor 86. The content requestor 86 may be configured to direct a content request to a device which selects the content package, for example the content package selector 40. The content request may include information such as the content type selection, the contextual characteristics (which may include the application contextual characteristics), channel selections, and other information as will be described in greater detail below. Thereafter the content requestor 86 may receive the content package and direct the content package to an application for output. Thus, the content requestor 86 may in some embodiments act as a point of contact between the apparatus 50 and the content package selector 40. Further, in some embodiments the content requestor may mask communications between the content package selector 40 and the content requestor.

In some embodiments the content requestor 86 may additionally or alternatively manage a user profile. The user profile may include information relating to the user of the apparatus 50, such as preferred content types, user permissions and passwords, device and application settings, account information, etcetera. The user profile may also include channel subscription information. Thereby, the content requestor 86 may in some embodiments manage this information by receiving and distributing the information as needed to and from the applications. The content requestor 86 may in some embodiments transfer a portion or the entirety of the user profile to the content package selector 40 as part of the content request. Thereby, in some embodiments the content package selector 40 may compile a database of user profile information. Further, in some embodiments the content requestor may mask communications between the content package selector 40 and the content requestor. Thereby the applications may be masked from the details of communications relating to authentication.

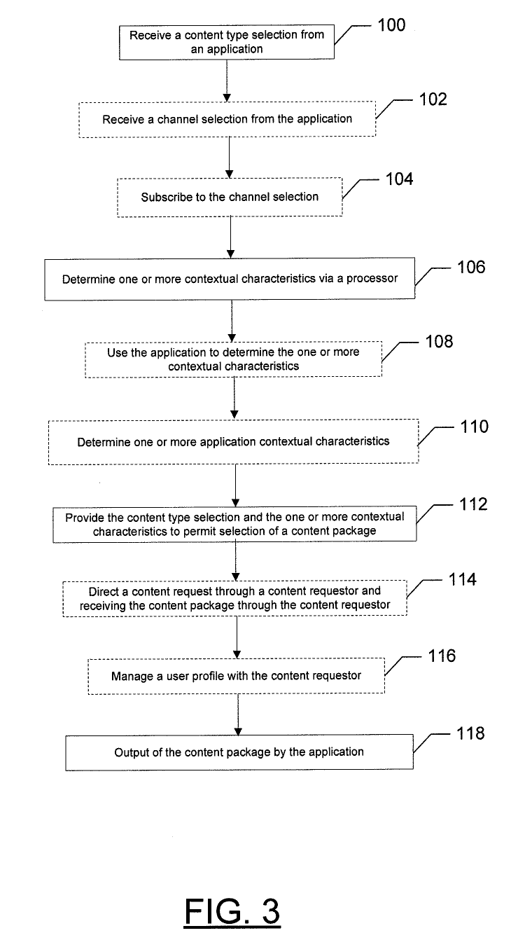

In terms of methods associated with embodiments of the present invention, the above-described apparatus 50 or other embodiments of apparatuses may be employed. In this regard, FIG. 3 is a flowchart of a system, method and program product according to example embodiments of the invention. It will be understood that each block of the flowchart, and combinations of blocks in the flowchart, may be implemented by various means, such as hardware, firmware, processor, circuitry and/or other device associated with execution of software including one or more computer program instructions. For example, one or more of the procedures described above may be embodied by a computer program product including computer program instructions. In this regard, the computer program instructions which embody the procedures described above may be stored by a memory device and executed by a processor of an apparatus. As will be appreciated, any such computer program instructions may be loaded onto a computer or other programmable apparatus (for example, hardware) to produce a machine, such that the resulting computer or other programmable apparatus embody means for implementing the functions specified in the flowchart block(s). These computer program instructions may also be stored in a computer-readable memory that may direct a computer or other programmable apparatus to function in a particular manner, such that the instructions stored in the computer-readable memory produce an article of manufacture the execution of which implements the function specified in the flowchart block(s). The computer program instructions may also be loaded onto a computer or other programmable apparatus to cause a series of operations to be performed on the computer or other programmable apparatus to produce a computer-implemented process such that the instructions which execute on the computer or other programmable apparatus implement the functions specified in the flowchart block(s).

Accordingly, blocks of the flowchart support combinations of means for performing the specified functions and program instruction means for performing the specified functions. It will also be understood that one or more blocks of the flowchart, and combinations of blocks in the flowcharts, can be implemented by special purpose hardware-based computer systems which perform the specified functions, or combinations of special purpose hardware and computer instructions.

In this regard, one embodiment of a method comprises receiving a content type selection from an application at operation 100. The method may additionally comprise receiving a channel selection from the application at operation 102. Further, in some embodiment the method may include subscribing to the channel selection at operation 104. The method may additionally comprise determining one or more contextual characteristics at operation 106. In some embodiments, as illustrated at operation 108, the method may further comprise using the application to determine the one or more contextual characteristics. Thus, in some embodiments the application itself determines the one or more contextual characteristics. In this regard, the method may further comprise determining one or more application contextual characteristics via a processor, at operation 110. Therefore, the method may determine contextual characteristics relating to the application itself, such as user inputs and application settings.

The method may additionally comprise providing the content type selection and the one or more contextual characteristics to permit selection of a content package at operation 112. Thus, the method may include providing information upon which the selection of the content package is based. In this regard, the selection of the content package may be based on a number of alternative or additional pieces of information. For example, information provided for selection of the content package may additionally or alternatively include the following: an identifier for the apparatus requesting content, a channel selection and/or subscription information including subscription parameters or removal of a subscription, semantic descriptions or parameters, user profile and/or account information, database parameters or search strings, a specified number of desired content segments for the content package, a specified selector for the content package (for example, content package selector 40), meta-data, and information for creating or updating a channel. Accordingly, the content package may be selected on the basis of various pieces of information in some embodiments.

In some embodiments the method may further comprise directing a content request through a content requestor and receiving the content package through the content requestor at operation 114. The content request may include the one or more contextual characteristics, content type selection, and/or the other information as described above. Additionally, in some embodiments the method may further comprise managing a user profile with the content requestor at operation 116. Also, the method may include providing for output of the content package by the application at operation 118. Accordingly, a content package may be outputted, such as by displaying the content package.

In some embodiments, certain ones of the basic operations (as, for example, illustrated in solid lines in FIG. 3) may be modified or further amplified as described above. In some embodiments additional optional operations may also be included (some examples of which are shown in dashed lines in FIG. 3). It should be appreciated that each of the modifications, optional additions or amplifications may be included with the basic operations either alone or in combination with any others among the features described herein. As such, each of the optional operations is combinable with operations 102, 104, 108, 110, 114, 116 either alone or with one, more than one, or all of the other optional operations in any combination.

In an example embodiment, an apparatus for performing the method of FIG. 3 and other methods described above may comprise a processor (for example, the processor 70) configured to perform some or each of the operations (100-118) described above. The processor may, for example, be configured to perform the operations (100-118) by performing hardware implemented logical functions, executing stored instructions, or executing algorithms for performing each of the operations. Alternatively, the apparatus may comprise means for performing each of the operations described above. In this regard, according to an example embodiment, examples of means for performing operations 100-118 may comprise, for example, the processor 70, the user interface 72, the communication interface 74, the content type selector 78, the channel selector 80, the contextual characteristic determiner 82, the GPS module 84, and the content requestor 86, and/or an algorithm executed by the processor for processing information as described above. However, the above-described portions of the apparatus 50 as they relate to the operations of the method illustrated in FIG. 3 are merely examples, and it should be understood that various other embodiments may be possible.

In some embodiments the operation 100 of receiving a content type selection from an application may be conducted by means, such as the user interface 72, the content type selector 78, and/or the processor 70. Further, the operations 102 of receiving a channel selection from the application and the operation 104 of subscribing to the channel selection may be conducted by means, such as the user interface 72, the channel selector 80, and/or the processor 70. Additionally, the operation 106 of determining one or more contextual characteristics, the operation 108 of using the application to determine the one or more contextual characteristics, and the operation 110 of determining one or more application contextual characteristics may be conducted by means, such as the contextual characteristics determiner 82, the GPS module 84, and/or the processor 70.

Further, providing the content type selection and the one or more contextual characteristics to permit selection of a content package at operation 112 and directing a content request through a content requestor and receiving the content package through the content requestor at operation 114 may be conducted by means, such as the content requestor 86, the communication interface 74, and/or the processor 70. Additionally, the operation 116 of managing a user profile may be conducted by means, such as the content requestor 86 and/or the processor 70. Also, the operation 118 of outputting the content package by the application may be conducted by means, such as the user interface 72 and/or the processor 70.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

That which is claimed:

1. An apparatus comprising at least one processor and at least one memory including computer program code, the at least one memory and the computer program code configured to, with the processor, cause the apparatus to:
receive a content type selection from an application;
determine one or more contextual characteristics via a processor;
provide the content type selection and the one or more contextual characteristics to permit selection of a content package; and
provide for output of the content package by the application.

2. The apparatus of claim 1, further configured to use the application to determine the one or more contextual characteristics.

3. The apparatus of claim 2, further configured to determine one or more application contextual characteristics.

4. The apparatus of claim 1, further configured to receive a channel selection from the application.

5. The apparatus of claim 4, further configured to subscribe to the channel selection.

6. The apparatus of claim 1, further configured to direct a content request through a content requestor and receive the content package through the content requestor.

7. The apparatus of claim 6, further configured to manage a user profile with the content requestor.

8. A method comprising
receiving a content type selection from an application;
determining one or more contextual characteristics via a processor;
providing the content type selection and the one or more contextual characteristics to permit selection of a content package; and
providing for output of the content package by the application.

9. The method of claim 8, further comprising using the application to determine the one or more contextual characteristics.

10. The method of claim 9, further comprising determining one or more application contextual characteristics.

11. The method of claim 8, further comprising receiving a channel selection from the application.

12. The method of claim 11, further comprising subscribing to the channel selection.

13. The method of claim 8, wherein providing the content type selection and the one or more contextual characteristics comprises directing a content request through a content requestor and receiving the content package through the content requestor.

14. The method of claim 13, further comprising managing a user profile with the content requestor.

15. A computer program product comprising at least one computer-readable storage medium having computer-executable program code portions stored therein, the computer-executable program code portions comprising:
program code instructions for receiving a content type selection from an application;
program code instructions for determining one or more contextual characteristics via a processor;
program code instructions providing the content type selection and the one or more contextual characteristics to permit selection of a content package; and
program code instructions providing for output of the content package by the application.

16. The computer program product of claim 15, further comprising program code instructions for using the application to determine the one or more contextual characteristics.

17. The computer program product of claim 16, further comprising program code instructions for determining one or more application contextual characteristics.

18. The computer program product of claim 15, further comprising program code instructions for receiving a channel selection from the application.

19. The computer program product of claim 18, further comprising program code instructions for subscribing to the channel selection.

20. The computer program product of claim 15, wherein program code instructions providing the content type selection and the one or more contextual characteristics comprise program code instructions for directing a content request through a content requestor and program code instructions for receiving the content package through the content requestor.
